(19) United States
(12) Patent Application Publication
(10) Pub. No.: US 2006/0042855 A1
(43) Pub. Date: Mar. 2, 2006

(54) Motor vehicle safety systems

(76) Inventor: Stephen Chan, Vancouver (CA)

Correspondence Address: LONG AND CAMERON, SUITE 1401 - 1166 ALBERNI STREET, VANCOUVER, BC, V6E 3Z3, CA

(21) Appl. No.: 10/928,157

(22) Filed: Aug. 30, 2004

(51) Int. Cl. B60K 28/14; B60T 7/22

(52) U.S. Cl. 180/276

(57) ABSTRACT

A motor vehicle safety system for a motor vehicle having wheels and tires on the wheels includes a hydraulically extendable elongate arcuate member in an elongate arcuate housing extending around an upper portion of each tires, and a valve operable in response to an impact on the impact sensor to apply hydraulic pressure from an oil supply system to the arcuate housing to displace the arcuate member along the arcuate housing from a retracted position in the arcuate housing to an extended position in which the arcuate member projects from the housing with an end located beneath the tire. Alternatively, the arcuate member may be released for displacement by gravity into its extended position. Rollers projecting from the arcuate member are in rolling engagement with the tire and with the ground on displacement of the arcuate member into the extended position.

### BACKGROUND OF THE INVENTION

1. Field of the Invention

The present invention relates to motor vehicle safety systems and, more particularly, to motor vehicle safety systems, which discontinue the driving of a vehicle by the wheels of the vehicle when the vehicle impacts against an obstruction, for example, a person or an object.

2. Description of the Related Art

In U.S. Pat. No. 1,604,752, issued Oct. 26, 1926, there is disclosed an automatic safety apparatus for automobiles, which has a transmission, including two gear trains for driving rear wheels of the automobile in opposite directions, and a double electromagnetic clutch for connecting one or the other of these gear trains to the rear wheels. This prior apparatus is such that, when the front of the vehicle impacts an object or person, one or more contacts on the front of the vehicle are closed, thereby operating a controller so as to operate the electromagnetic clutch to reverse the drive to the rear wheels.

This prior apparatus, however, is complicated, bulky and expensive and, therefore, is impractical in a modern motor vehicle.

U.S. Pat. No. 3,899,935, issued Aug. 19, 1975, discloses apparatus for automatically reversing or stopping the transmission of a vehicle on impact of the vehicle with a person or object. For this purpose, a sensor bar, mounted on the rear end of the vehicle, is deflected on impact with an object so as to tilt an end of an arm upwardly, thereby releasing a piston to move under the action of a spring. The piston pulls a cable, which, in turn, operates a transmission control panel to put the vehicle into reverse.

### BRIEF SUMMARY OF THE INVENTION

It is an object of the present invention to provide a novel and improved motor vehicle safety system which, when installed on a vehicle, is unobtrusive and which interrupts contact between the tires of the vehicle and the ground when the vehicle impacts against an obstruction.

According to the present invention, there is provided a motor vehicle safety system on a motor vehicle having front and rear wheels, with tires on the wheels, the motor vehicle safety system comprising an elongate arcuate housing extending around upper portions of the tires of at least one of the wheel pairs, with an extendable elongate arcuate member in the housing. The vehicle is also provided with an impact sensor which, in response to an impact, displaces the arcuate member along the arcuate housing from a retracted position in the arcuate housing to an extended position, in which the arcuate member projects from the housing and an end of the arcuate member is located beneath the tire. Rollers on this end of the arcuate member project from the arcuate member for rolling engagement with the tire and with the ground, and have axes of rotation extending transversely of the arcuate member.

With this safety system, when the arcuate member is extended from the arcuate housing, in response to an impact on the impact sensor, the rollers on the arcuate member are interposed between the respective tires and the ground, so that the tires are no longer in fictional driving contact with the ground and, therefore, the vehicle is no longer driven forward.

### BRIEF DESCRIPTION OF THE DRAWINGS

The invention will be more readily understood from the following description of embodiments thereof illustrated, by way of example, in the accompanying drawings, in which:—

FIG. 1 shows a diagrammatic view in side elevation of a motor vehicle equipped with motor vehicle safety devices according to a first embodiment of the present invention;

FIGS. 2 through 5 show diagrammatic broken-away views of a front portion of the vehicle of FIG. 1 with one of the motor vehicle safety devices of FIG. 1 in four successive operational conditions;

FIG. 6 shows a view in transverse cross-section through the safety device of FIGS. 2 through 5, taken along the line 6-6 of FIG. 2;

FIG. 7 shows a view similar to that of FIG. 6, but taken along the line 7-7 of FIG. 2;

FIG. 8 shows a broken-away view, taken in transverse cross-section along the line 8-8 of FIG. 5, through part of a vehicle tire and an end portion of a part of the safety device of FIGS. 2 through 5;

FIG. 9 shows a plan view of parts of the safety device of FIGS. 2 through 5 in a retracted condition;

FIG. 10 shows a view corresponding to that of FIG. 9, but with the safety device in an extended condition;

FIG. 11 shows a view in side elevation, and partly broken away in cross-section, of of the safety device of FIGS. 2-5;

FIG. 12 shows a view taking in transverse cross-section along the line 12-12 of FIG. 10;

FIG. 13 diagrammatically illustrates a system including a sensor and associated components for operating the safety devices of FIGS. 1 through 12;

FIG. 14 shows a circuit with an impact sensor for releasing the arcuate member of FIGS. 2-10 14 for displacement from its housing; and

FIG. 15 diagrammatically illustrates a hydraulic system operated by a sensor which may be employed in place of the system shown in FIG. 13 for operating the safety devices.

### DESCRIPTION OF THE PREFERRED EMBODIMENTS

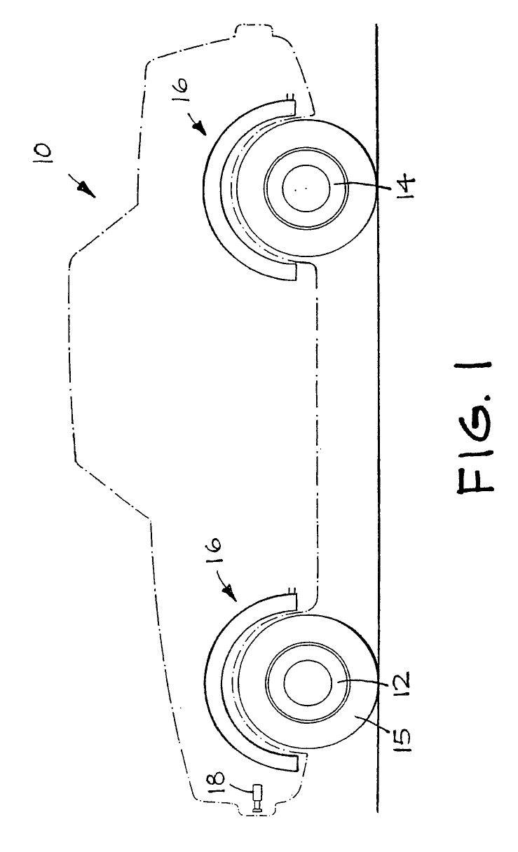

In FIG. 1 of the accompanying drawings, there is diagrammatically illustrated a motor vehicle indicated generally by reference numeral 10, which has a pair of front wheels, one of which is indicated by reference numeral 12, and a pair of rear wheels, one of which is indicated by reference numeral 14, each of the wheels being provided with a tire 15 and a respective arcuate housing indicated generally by reference numeral 16.

An impact sensor 18 is provided at the front of the vehicle 10.

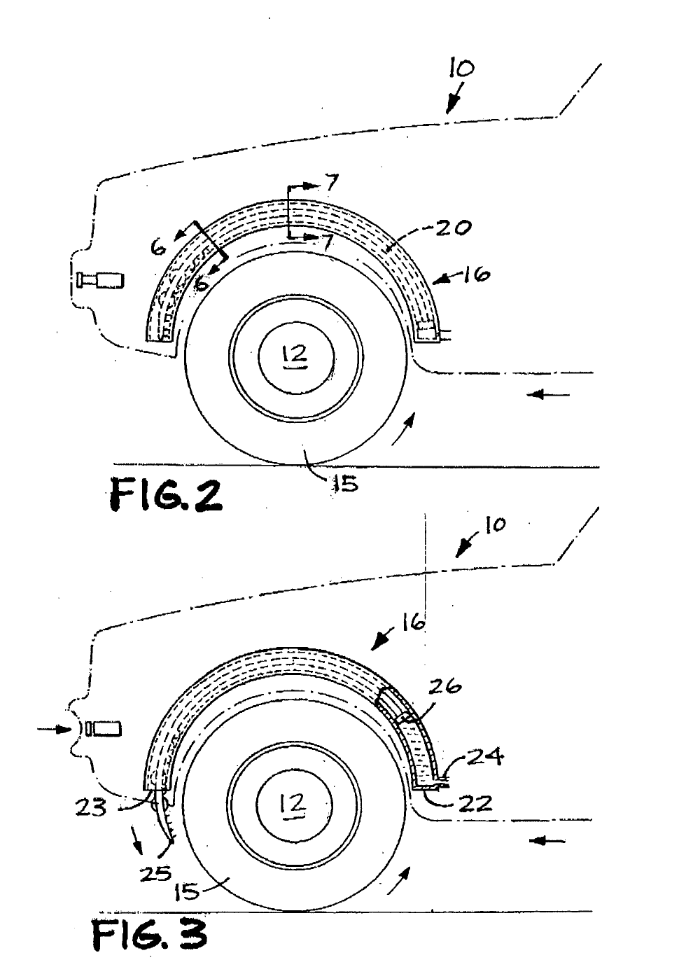

As shown in greater detail in FIG. 2, each arcuate housing 16 contains an elongate, arcuate strip-shaped member 20 extending along the interior of the arcuate housing 16, a closed end 22, with an inlet 24 for hydraulic fluid communicating with the interior of the housing 16 adjacent, and an end 23 opposite from the closed end 22.

The arcuate member 20 has, at an inner end thereof, three pistons 26, which are slidably received three arcuate cylinders 27 in the housing 16 so as to form three piston and cylinder devices for displacing the arcuate member 20 along the housing 16 in response to a supply of hydraulic fluid into the housing 16 through the fluid inlet 24, which communicates with the cylinders 27. The pistons 26 are connected to the trailing end of the arcuate member 20 by arcuate piston rods 29, on which compression springs 31 are provided. The springs 31 act between the arcuate member 20 and the cylinders 27 to assist the displacement of the arcuate member 20.

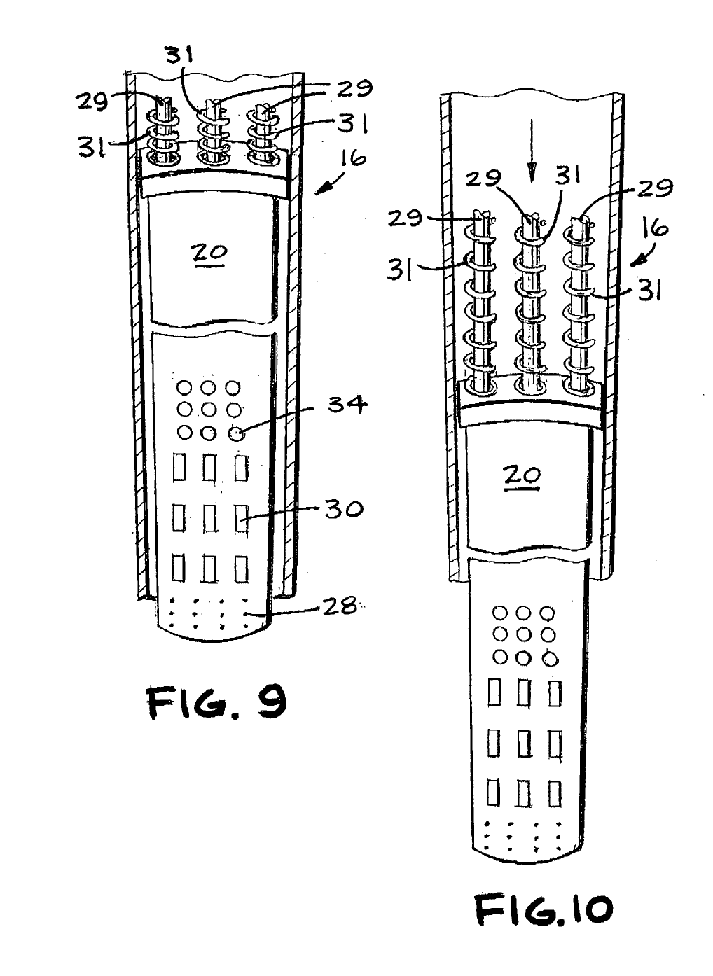

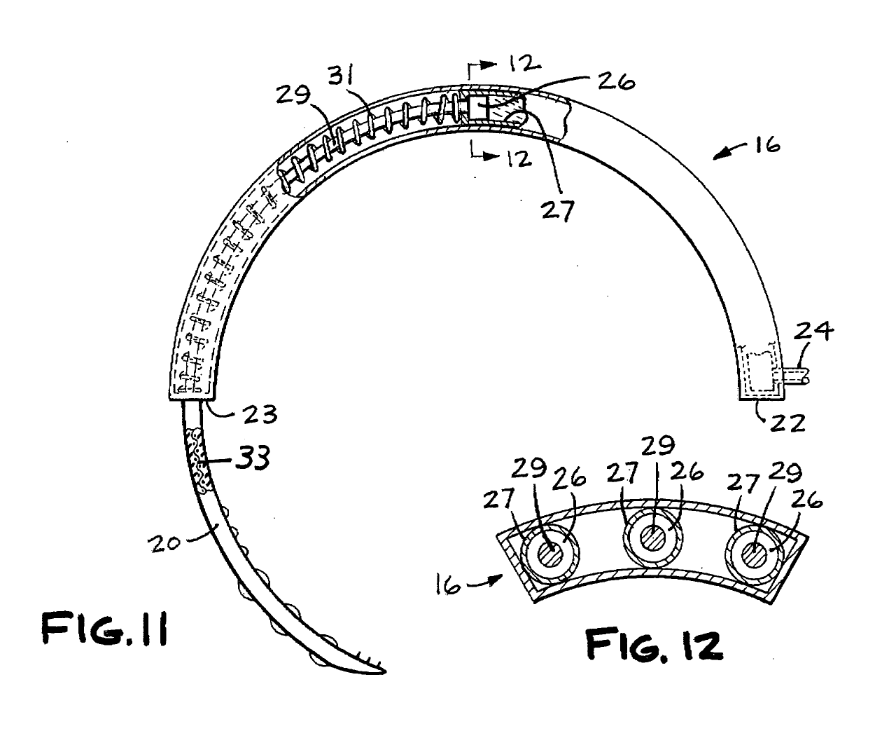

As shown in FIGS. 9 and 10, the housing 16 is slightly tapered along the length of the housing 16 so that as the pistons 26 are displaced along the housing 16, the arcuate member 20 eventually becomes wedged in the housing 16, as shown in FIG. 10, and can no longer be displaced further along the housing 16 by the pressure of the hydraulic fluid and the action of the springs 31.

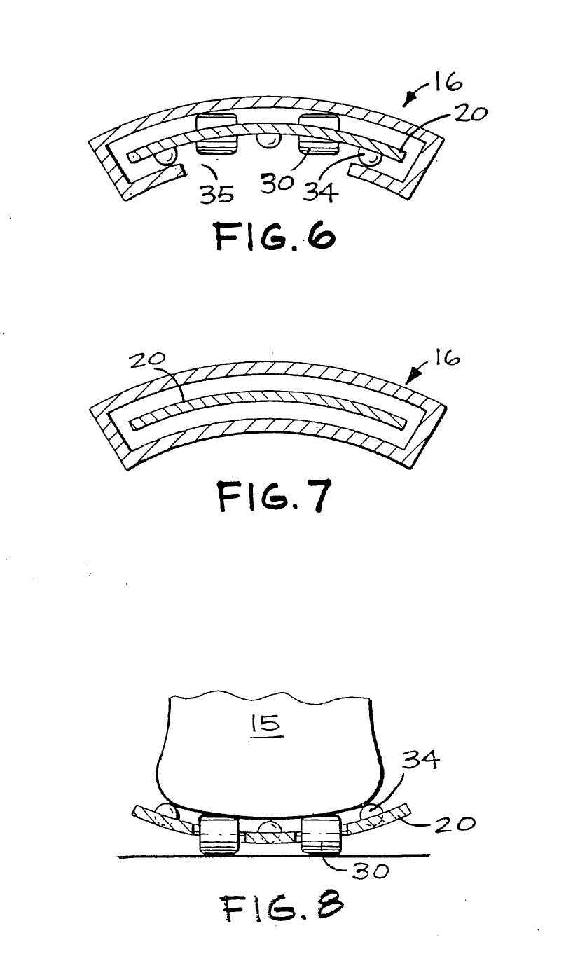

As can be seen from FIGS. 6 through 10, the arcuate member 20 is a strip-shaped member of curved cross-section, which at a first end 25 thereof is formed with a plurality of spikes 28, which project from the arcuate member 20 toward the tread of the tire 15.

The end portion 26 also has rollers 30, which have axes of rotation extending transversely of the arcuate member 20 and which project from opposite sides of the arcuate member 20, i.e. from the side of the arcuate member 20 facing the tire 15 and from the opposite side of the arcuate member 20, so that, on extension of the arcuate member 20 from its housing, into an extended position in which it is shown in FIG. 5, the rollers become interposed between the tread of the tire 15 and the ground, which is indicated by reference 32 in FIG. 7.

The center of curvature of the arcuate housing 16 is offset from that of its respective wheel 12 to facilitate the correct guidance of the end 25 of the arcuate member 20 is guided toward the tread of the tire 15 as the end 25 approaches the ground 32.

Referring again to FIG. 8, the end portion 26 of the arcuate member 20 is also provided with an array of ball bearings 34, the purpose of which is to prevent contact between the end portion 26 of the arcuate member 20 and the tread of the tire 15. Further ball bearings (not shown) may be provided in the end portion 26 of the arcuate member 20 between the spikes 28 and the rollers 30.

The arcuate member 20 is made of a steel mesh core 33, shown in a portion of the arcuate member 20 broken away in section in FIG. 11, which embedded in rubber and the arcuate member 20 is therefore semi-rigid but flexible.

The operation of the above described embodiment of the invention is now described with reference to FIGS. 2 through 10.

As illustrated in FIG. 2, the arcuate member 20 is normally located in a retracted position in the arcuate housing 16. In this retracted position, the pistons 26 are located close to the fluid inlet 24 of the housing 16.

When the vehicle 10 impacts against an object, the sensor 18 is actuated, as shown in FIG. 3, to cause a supply of hydraulic fluid under pressure to be introduced into the housing 16 through the fluid inlet 24.

The inflow of hydraulic fluid into the housing 16 displaces the piston 26, and therewith the arcuate member 20, along the housing 16, so that the end portion 26 of the arcuate member 20 is extended through the end 23 of the housing 16.

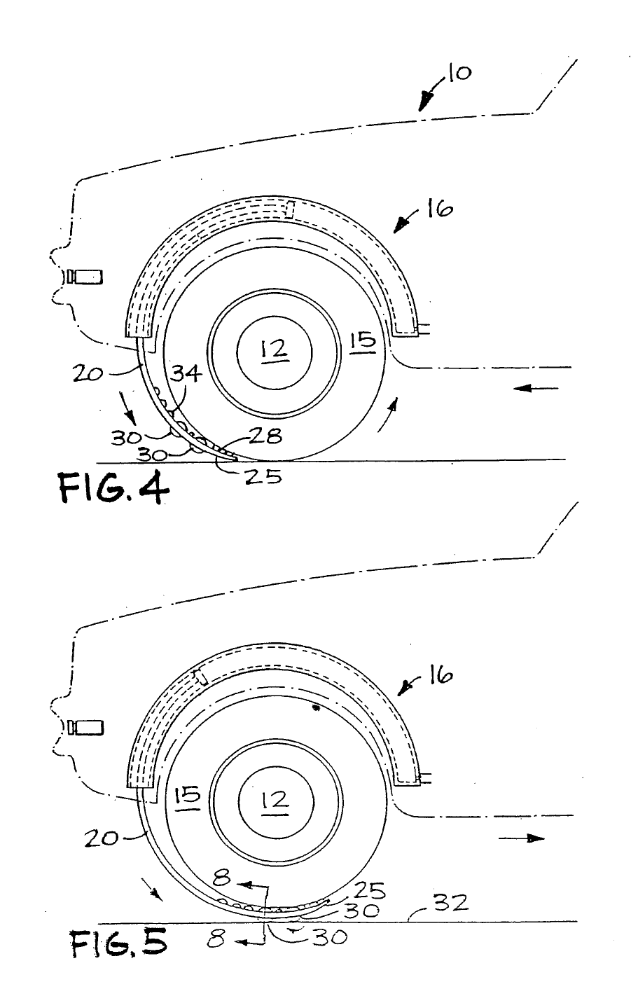

When the arcuate member 20 has been partially extended from the housing 16, as illustrated in FIG. 4, the spikes 28 on the end portion 26 of the arcuate member 20 engage the tread of the tire 15.

Then, as illustrated in FIG. 5, the rollers 30 are drawn between the tire 15 and the ground 32, so that the tire 15 is no longer in driving contact with the ground 32, and in fact, the rollers 30 are rotated in a direction such as to cause the rotation of the tire 15 to tend to drive the vehicle 10 rearwardly. In this fully extended position, the pistons 26 are wedged in the housing 16 as mentioned above, and as illustrated in FIG. 10.

As will be apparent, instead of tapering that the housing 16 to produce such wedging, it is alternatively possible to provided a stop (not shown) on the housing 16 for engaging a projection (not shown) on the arcuate member 20 to limit the displacement of the latter.

As can be seen from FIG. 6, the underside of the arcuate housing 16, at the forward end of the arcuate housing 16, is formed with a longitudinally extending gap 35 to avoid obstructing the rollers 30 when the arcuate member 30 is in its retracted position.

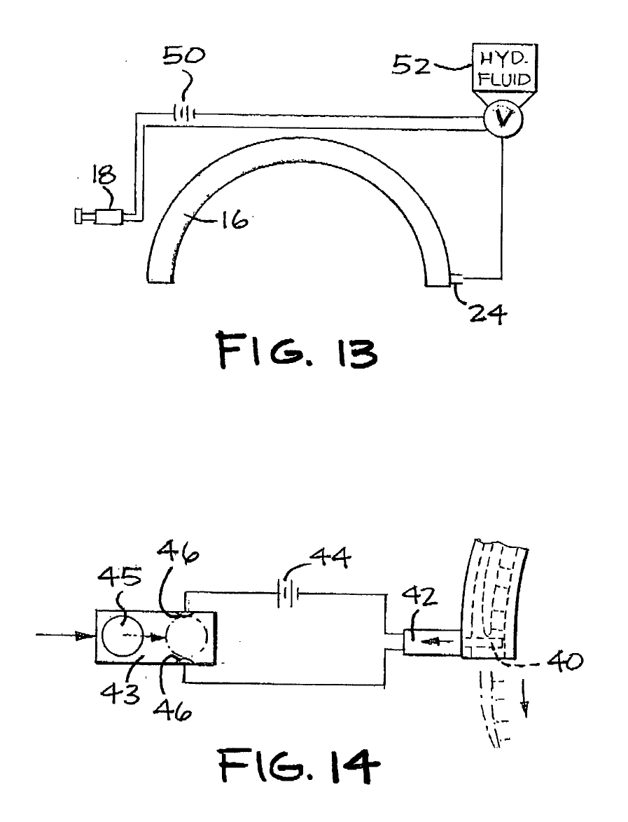

Referring now to a modified embodiment of the present invention illustrated in FIGS. 11 and 12, an elongate arcuate housing 116, having a closed end 122 and an open opposite end 123, contains an arcuate member 120, which extends along the interior of the housing 116 and which, as shown in FIG. 12, is of transversely curved cross-section.

The arcuate member 120 is connected to an outer tube 140, which extends along the arcuate member 120, and the arcuate tube 140 has a closed outer end 142 and an open inner end 144.

An inner tube 146, which is fixed relative to the housing 116, extends longitudinally along this outer tube 140 and has an open outer end 148 and a closed inner end 150, adjacent to which a fluid supply inlet 152 communicates with the interior of the inner tube 148.

The arcuate member 120 has an outer end portion 126, which is provided with spikes 128, rollers 113 and ball bearings 134, corresponding to the spikes 28, the rollers 30 and the ball bearings 34 of the first-described embodiment of the present invention.

In operation, hydraulic fluid is supplied under pressure through the fluid inlet 152, in response to actuation of a sensor, and this hydraulic fluid forces the outer tube and, therewith, the arcuate member 120 along the arcuate housing 116 to interpose the rollers 130 between a vehicle tire and the ground, in a manner analogous to that described with reference to the first-mentioned embodiment of the present invention.

FIG. 13 shows means for supplying the hydraulic fluid under pressure to the arcuate cylinder 27 in the housing 16 in response to the actuation of the sensor 18, which means comprises an electrical switch (not shown) in the sensor 18 for completing a circuit from a battery 50 to open a valve V to connect the vehicle hydraulic system 52 to the hydraulic fluid inlet 24.

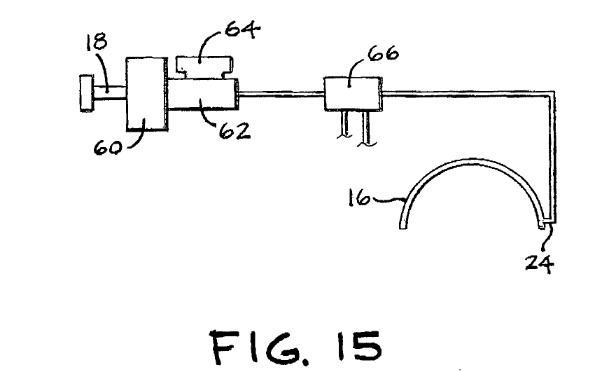

FIG. 14 illustrates a retainer device for retaining the arcuate member 20 against the action of the springs 31 prior to an impact.

This retainer device has a stop member 40, which projects into the housing 16 to form an abutment for the leading end of the arcuate member 20. The stop member 40 is retractable, to release the arcuate member 20, by means of a solenoid 42 connected to the stop member, an inertia switch 43 and a battery 44. When the vehicle experiences an impact, an electrically conductive ball 45 in the inertia switch 43 is moved by inertia to interconnect a pair of contacts 46, thereby causing energization of the solenoid 42 by the battery 44 to retract the stop member 40.

FIG. 14 shows a modified system for pressurizing the arcuate cylinders 27 in place of the apparatus shown in FIG. 13.

In the system of FIG. 14, the senso 18 is connected throgh a power booster 60 of a type common in vehicle hydraulic brake systems. The power booster 60, in reponse to operation of the impact sensor 18 when the vehicle experiences an impact, in turn operates a master cylinder 62 to supply hydraulic fluid from a fluid reservoir 64 through a combination valve 66, also common in vehicle hydraulic systems, to the fluid inlet 24 of the arcuate cylinders 27 in the housing 16.

As will be apparent to those skilled in the art, various modifications may be made to the above-described embodiments of the present invention within the scope of the accompanying claims. For example, the present safety device could be provided only on the front pair of wheels of the vehicle, or only on the rear pair of wheels of the vehicle.

A further possibility would be to use a pneumatic system, similar to those used for deploying air bags in vehicles, for extending the arcuate member from the arcuate housing

Also, instead of employing only one impact sensor at the front of the vehicle, it is also possible to employ at least one sensor at each side and the rear of the vehicle for initiating the operation of the present motor vehicle safety device.

1. A motor vehicle safety system, comprising:—
a motor vehicle;
the motor vehicle having front and rear pairs of wheels and tires on the wheels;
an elongate arcuate housing extending around an upper portion of the tire of at least one of the pairs of wheels;
an elongate arcuate member in the housing;
the arcuate member having first and second ends;
an impact sensor on the vehicle;
means operable in response to an impact on the impact sensor to displace the arcuate member along the arcuate housing from a retracted position in the arcuate housing to an extended position in which the arcuate member projects from the housing and the first end is located beneath a respective one of the tires; and
rollers on the first end of the arcuate member, the rollers projecting from the arcuate member for rolling engagement with the tire and with the ground on displacement of the arcuate member into the extended position;
the rollers having axes of rotation extending transversely of the arcuate member.

2. A motor vehicle safety system as claimed in claim 1, wherein the arcuate housing has a center of curvature, which is offset from that of the wheel so as to direct the first end of the arcuate member toward the tread of the respective tire on extension of the arcuate member from the housing.

3. A motor vehicle safety system as claimed in claim 1, wherein the first end of the arcuate member has spikes projecting from the arcuate member toward the tread of the respective tire.

4. A motor vehicle safety system as claimed in claim 1, including ball bearings on the first end of the arcuate member, the ball bearings facing the respective tire.

5. A motor vehicle safety system, comprising:—
a motor vehicle;
the motor vehicle having front and rear pairs of wheels and tires on the wheels;
an elongate arcuate housing extending around an upper portion of the tire of at least one of the pairs of wheels;
an hydraulically extendable elongate arcuate member in the housing;
the arcuate member having first and second ends;
an impact sensor on the vehicle;
an oil supply system;
a valve operable in response to an impact on the impact sensor to apply hydraulic pressure from the oil supply system to the arcuate housing to displace the arcuate member along the arcuate housing from a retracted position in the arcuate housing to an extended position in which the arcuate member projects from the housing and the first end is located beneath a respective one of the tires; and
rollers on the first end of the arcuate member, the rollers projecting from the arcuate member for rolling engagement with the tire and with the ground on displacement of the arcuate member into the extended position;
the rollers having axes of rotation extending transversely of the arcuate member.

6. A motor vehicle safety system as claimed in claim 5, including a piston on the second end of the arcuate member a piston chamber extending along the arcuate housing, the piston being slidable along the piston chamber.

7. A motor vehicle safety system as claimed in claim 5, wherein the arcuate housing has an oil inlet connected to the oil supply and the piston chamber is defined by an arcuate tube extending from the oil inlet along the interior of the arcuate housing.

8. A motor vehicle safety system as claimed in claim 5, wherein the arcuate housing has a center of curvature which is offset from that of the wheel so as to direct the first end of the arcuate member toward the tread of the respective tire on extension of the arcuate member from the housing.

9. A motor vehicle safety system as claimed in claim 5, wherein the first end of the arcuate member has spikes projecting from the arcuate member toward the tread of the respective tire.

10. A motor vehicle safety system as claimed in claim 5, including ball bearings on the first end of the arcuate member, the ball bearings facing the respective tire.

11. A motor vehicle safety system as claimed in claim 5, wherein the arcuate member is one of a plurality of arcuate members, the system including a piton on each of the arcuate members and piston chambers extending along the arcuate housing, the pistons being slidable along respective ones of the piston chambers.

12. A motor vehicle as claimed in claim 5, including a compression spring biassing the arcuate member towards the extended position.

13. A motor vehicle safety system, comprising:—
a motor vehicle;
the motor vehicle having wheels and tires on the wheels;
an elongate arcuate housing extending around an upper portion of each tires;
an elongate arcuate member in the housing;
the arcuate member having first and second ends;
an impact sensor on the vehicle;
means operable in response to an impact on the impact sensor to release the arcuate member for displacement of the arcuate member by gravity along the arcuate housing from a retracted position in the arcuate housing to an extended position in which the arcuate member projects from the housing and the first end is located beneath the tire; and
rollers on the first end of the arcuate member, the rollers projecting from the arcuate member for rolling engagement with the tire and with the ground on displacement of the arcuate member into the extended position;
the rollers having axes of rotation extending transversely of the arcuate member.

14. A motor vehicle safety system as claimed in claim 13, wherein the arcuate housing has a center of curvature which is offset from that of the wheel so as to direct the first end of the arcuate member toward the tread of the respective tire on extension of the arcuate member from the housing.

15. A motor vehicle safety system as claimed in claim 13, wherein the first end of the arcuate member has spikes projecting from the arcuate member toward the tread of the respective tire.

16. A motor vehicle safety system as claimed in claim 13, including ball bearings on the first end of the arcuate member, the ball bearings, facing the respective tire.
